(19) United States
(12) Patent Application Publication
(10) Pub. No.: US 2012/0200457 A1
(43) Pub. Date: Aug. 9, 2012

(54) System framework for mobile device location

(75) Inventors: Farrokh Farrokhi, San Ramon, CA (US); Edmund Gregory Lee, Palo Alto, CA (US); Dickson T. Wong, Burlingame, CA (US); Arthur J. Collmeyer, Incline Village, NV (US)

(73) Assignee: etherWhere Corporation

(21) Appl. No.: 13/134,540

(22) Filed: Jun. 10, 2011

Related U.S. Application Data
(60) Provisional application No. 61/458,371, filed on Nov. 23, 2010.

(51) Int. Cl. G01S 19/46

(52) U.S. Cl. 342/357.29

(57) ABSTRACT

A method for estimating the location of a mobile Wi-Fi signal receiver from a database of independently obtained survey data, each survey datum consisting of a surface of location derived from a composite GPS signal, together with a Wi-Fi signature measured concurrently with the GPS signal measurement, is disclosed. The method comprises receiving a Wi-Fi signature, measured and recorded by said mobile. Wi-Fi signal receiver, at the location to be estimated; extracting from the database, an algorithmically-determined subset of surfaces of location, utilizing the Wi-Fi signature recorded by said mobile Wi-Fi signal receiver, and estimating the location of said mobile Wi-Fi signal receiver from said algorithmically-determined subset of surfaces of location. In one embodiment, the algorithmically-determined subset consists of those surfaces of location with Wi-Fi signatures identical to the mobile Wi-Fi signature; and the estimate of the location of said mobile Wi-Fi signal receiver is determined as the point for which the sum of the squares of the distances to each of the surfaces of location included in said algorithmically-determined subset is minimized.

### CROSS-REFERENCE TO RELATED APPLICATIONS

This application claims the benefit of U.S. Provisional Application No. 61/458,371; entitled “System Framework for Mobile Device Location”, filed on Nov. 23, 2010. This application further claims priority under 35 U.S.C. §120 from pending U.S. patent application Ser. No. 12/924,618, filed on Oct. 1, 2010, and Ser. No. 12/807,463, filed on Sep. 7, 2010, entitled “System Framework for Mobile Device Location”, a Notice of Allowance for U.S. patent application Ser. No. 12/807,463 having been mailed on May 25, 2011.

### STATEMENT REGARDING FEDERALLY SPONSORED RESEARCH OR DEVELOPMENT

Not Applicable

### BACKGROUND OF THE INVENTION

This invention relates to techniques for determining location and, specifically, to techniques that utilize the NAVSTAR Global Positioning System (GPS).

The NAVSTAR Global Positioning System (GPS) developed by the United States Department of Defense uses a constellation of between 24 and 32 Medium Earth Orbit satellites that transmit precise microwave signals, which allows devices embodying GPS sensors to determine their current location. Initial applications were predominantly military; the first widespread consumer application was navigational assistance.

With the explosive growth in mobile communications devices, a new wave of location-based applications is emerging. These applications are characterized by a requirement for device-centered maps. One example is a form of “Yellow Pages” in which a map centered at the location of the mobile device presents user-selected establishments (e.g., barber shops) in situ. Another example would be an application enabling one to locate, on a device-centered map, members of his or her social network. In these applications, location involves but two dimensions (North/South and East/West). Thus, while GPS is generally capable of providing three dimensional locations (or 3D GPS fixes), the altitude, or z dimension is typically inhibited. In the interest of simplicity, the narrative which follows ignores the three dimensional potential of GPS-based location.

Outdoors, GPS (using four or more satellites) is a reliable and accurate source of the location information essential to enable a device-centered map to be served across a network to a mobile device. Indoors, however, today's GPS receivers, even when operating in 2D mode (using just three satellites and, most commonly, a pseudo satellite located at the center of the earth), do not have sufficient sensitivity to provide reliable and accurate location information. As a result, location-based applications typically utilize GPS outdoors (where at least three satellites are generally available), and the services of any of several location service providers, where GPS fails to yield location information. An example of such a service is that provided by Google to cellular network subscribers, wherein the location of the requesting subscriber is estimated using the relative strength of signals from base stations in the vicinity of the subscriber.

Location services are built around proprietary databases, compiled by location service providers. These databases are essentially compilations of the locations of terrestrial transmitting towers (beacons), or compilations of the signal-strength contours surrounding these beacons, or compilations of the locations together with the associated signal-strength contours. The most commonly available beacons are cellular towers and wireless (e.g., Wi-Fi) access points. A subscriber (to a location service) provides the ID's and (optionally) the associated signal strengths of any beacons detectable by his or her mobile device, and the location service provider responds with its best estimate of the location of the device. For the purpose of this discussion, the system employed by a location service provider is referred to as a Mobile Device Location System (MDLS).

FIG. 1 describes a typical Mobile Device Location System employed by a location service provider to compile its Beacon. Location/Signal-Strength Contour Database (BLDB)—the database of beacon locations and/or beacon-associated signal-strength contours utilized in the servicing of subscriber requests. Key elements of this system (in addition to the aforementioned BLDB) are the Beacon Survey Database (BSDB), the Beacon Location/Signal-Strength Contour Engine (BLEN) and the Subscriber Device Location. Engine (SLEN). The Beacon Survey Database is comprised of measurements taken at various times and places for use by the BLEN in the compilation of the BLDB which, in turn, is used by SLEN to estimate the location of a subscriber's mobile device. As survey measurements are often taken within range of multiple beacons, it is necessary to demultiplex the measurement data for storage in BSDB, which is structured around beacons.

Whether the beacons are cellular towers or wireless access points—the measurement processes are largely identical. Measurements are taken using instruments similar to (and in some cases, identical to) the mobile communications devices the MDLS has been designed to locate. The standard mode of operation is to traverse the geography of interest with a measuring instrument, pausing periodically to record its location (using GPS) together with the ID's and signal-strengths of any beacons detectable by the device. As these measurements accumulate, beacon locations and/or beacon-associated signal-strength contours are generated and thereafter continually updated by the BLEN, to enable the generation of accurate and reliable estimates of location in response to subscriber requests.

To appreciate the limitations of an MDLS as described in FIG. 1, it is useful to consider a few examples. As indicated above, the most common types of beacons in use today are cellular towers and wireless access points. While the former provide broader coverage in the aggregate, their precise location does not, in general, enable triangulation to an accurate estimate of subscriber location. Cell-tower-based service providers have thus opted to construct signal-strength contours to reduce the estimation error. In this case, the BLEN further demultiplexes the beacon survey data, by signal strength, creating sets of coordinates reflecting a specific signal strength measured from a specific cell tower. With 2D curve fitting, these sets of coordinates become signal-strength contours, for cataloging in the BLDB. On the receipt of a request from a subscriber, the SLEN applies the information provided (by the subscriber) to generate its estimate of the subscriber's location. Methods for generating such estimates are well known in the art. One straightforward approach would be to intersect the contours associated with the cell towers/signal strengths supplied with the subscriber's request. Where these contours fail to intersect at a unique common point, a least squares calculation could be used to estimate the subscriber's location. In corner cases (e.g., where just one or two cell towers are detectable), other estimation algorithms would be applied.

While the signal-strength contour approach is fundamentally sound and works indoors and out, commercial cellular systems do not support the accuracy expected by subscribers, who have become accustomed to the accuracy provided (outdoors) by GPS.

Given the ubiquity of GPS, viability compels location service providers to consider the alternative of an access-point-based service. Providing access-point-based services requires a different approach, inasmuch as the task of developing a database of wireless signal-strength contours is virtually impossible owing to the inability of GPS to provide thorough coverage in the vicinity of typically-indoor access points. Inasmuch as signal strength measurements are generally discontinuous across exterior walls, precluding the interpolation of signal strength contours across the length and breadth of buildings (from measurements taken on the periphery), there are really no practical alternatives that leverage the ubiquity of GPS.

Rao and Siccardo (U.S. Pat. No. 6,269,246) describe a method for estimating the location of a mobile device by comparing a fingerprint of the RF spectrum captured by the mobile device with an ensemble of fingerprints, each with an associated location, resolving the closest matching fingerprint, and selecting its associated location as the estimate of the location of the mobile device. However, without cost-effective means for developing and maintaining a database of tens of indoor fingerprints, for perhaps 500M indoor access points, the practicality of the method is limited.

Agrawala and Youssef (U.S. Pat. No. 7,406,116) describe a method for estimating the location of a mobile device utilizing multiple radio maps (one for each set of access points detectable by the mobile device within the service area), which define the distribution of signal strength (for each access point) at surveyed locations throughout the service area. Their radio maps are compiled through the systematic calibration of signal strength(s) at surveyed locations within the service areas, a measurement process similar to that contemplated in Rao and Siccardo. The estimate of the location of the mobile device is then determined as the point of measurement at which the conditional probability of the reported vector of signal strengths is maximized. The practicality of this solution is likewise limited owing to the prohibitive cost of creating maps for all of the nearly 500M indoor access points operational today.

Morgan, et al (U.S. Pat. No. 7,403,762) describe a method of building a reference database of access point locations which involves traversing the target area in a programmatic route to avoid arterial bias. Measurements obtained for a given access point are then used to reverse triangulate the position of the detected access point. The location of a mobile device, reporting its detection of specific access points together with the associated signal strengths, is then accomplished using one of several location-determination algorithms. With the exception of access points deep in the interior of large buildings or high above the ground floor, which may go unobserved, this method leverages the ubiquity of GPS, and thus qualifies as being more practical than either of the two previous methods. Still, the task of systematically mapping 500M access points is daunting, if not prohibitively expensive.

In addition, U.S. Pat. No. 7,403,762 further describes a reference database of access point locations each with its associated signal fingerprint information, consisting of the signal strengths of the messages received from the access point as well as the locations recorded at the several points of measurement used to determine the location of the access point itself. With sufficient measurements per access point, this database could be used to construct signal strength contours, with the location of the mobile device determined by “intersecting” the contours associated with the access points/signal strengths reported by the mobile device, but its utility as such would fall considerably short, as the associated fingerprint information would largely be limited to signal strengths measured outdoors, and thus provide little insight as to signal strengths measured indoors. Useful or not, the task of developing and maintaining such a database remains daunting.

Externally, the growth in applications built on the assumption of broadband access suggests that as mobile broadband traffic searches for relief from the cost and congestion of the cellular networks, location-based applications will increasingly favor access-point-based location services. The demand for access-point-based services exposes a need in the art for an MDLS framework to enable the rapid, inexpensive compilation and maintenance of a comprehensive AP Survey Database, enabling the location of subscribers with the accuracy and efficiency required by current and contemplated location-based applications.

### BRIEF SUMMARY OF THE INVENTION

In general, the object of the present invention is to provide an MDLS framework to enable the rapid and inexpensive compilation and maintenance of a comprehensive AP Survey Database, to support the location of subscribers with the accuracy and efficiency required by current and contemplated location-based applications. As the repository for field measurements, applied ultimately to estimate the locations of subscribers' mobile devices, the AP Survey Database influences virtually every metric of importance to the operators as well as the subscribers of location services. Coverage must be complete; measurements must be easily and efficiently obtained, using accurate but inexpensive instruments. And the real-time computation associated with estimating subscriber locations with acceptable accuracy must be manageable.

The frameworks of mobile device location systems in use today are typically built on Beacon Survey Databases constructed with the aid of 2D GPS fixes. Estimates of subscriber location are then derived using cues (beacon ID's, signal strengths) supplied by the subscriber's mobile device. While cell-tower-based systems provide excellent coverage, the accuracy indoors is generally unacceptable. Access-point-based systems, with the potential for significantly improved accuracy, have yet to demonstrate their viability, owing to the cost of developing and maintaining the AP Survey Database.

To address the challenges facing today's access-point-based systems, a new MDLS framework (FIG. 2a) is disclosed. While the proposed framework bears a resemblance to the framework of today's MDLS, it is conceptually quite different. On the surface, an obvious difference is the replacement of the Beacon Survey Database with the Surfaces of Location Database (SLDB), and the Beacon Location/Signal-Strength Contour Database with a Signature Database (SGDB). The principal difference, however, flows from the underlying thesis that “imperfect” GPS data recordings—recordings which fail to yield sufficient information to generate a 2D GPS fix—collected indoors, can provide the foundation for an effective access-point-based MDLS. This thesis, underlying the proposed framework, affects the measurement process as follows: instead of recording a 2D GPS fix together with the ID's and signal-strengths of AP's detectable by the measuring instrument, GPS data are recorded at different times and different places using different instruments, without regard for the ability of the data to yield a 2D GPS fix. The subsequent processing of the recorded GPS data, for the purpose of estimating subscriber location, is detailed in the description of an MDLS implementation of this thesis (see below).

A convenient corollary of this thesis is that it enables the enlistment of subscribers in the measurement process. Under the existing framework(s), subscribers do not participate in the measurement process, requesting location services when GPS has failed to yield a 2D fix. Under the proposed framework, a request for location service could include GPS data (even though GPS has failed to produce a 2D fix), along with the ID's and signal strengths of any AP's detectable by the subscriber's mobile device. (To the extent a subscriber supplies any information for the purpose of obtaining his or her location, he or she has voluntarily disclosed his or her location; hence the proposed enlistment introduces no issues of privacy.)

Finally, this thesis and the resulting framework favor a thin-client implementation, which, in turn, enables the application of sophisticated signal processing techniques to reduce significantly the minimum signal strength required to acquire GPS satellites indoors.

FIG. 2a illustrates the thin-client approach to the extraction of GPS satellite signals from the composite GPS signal. The GPS measurement data input to the MDLS consists of the composite GPS signal for processing offline, rather than a 2D fix as is the case in today's MDLS. Moreover, instead of compiling a database of AP locations from 2D fixes, the proposed framework envisions a database of wireless signatures for use in locating subscribers directly. The GPS Signal Processor (GPSP) extracts surfaces of location (e.g., spheres and hyperplanes) which are catalogued by signature (a signature being the set of AP's detected at the point of measurement together with their associated signal strengths) in the Surfaces of Location Database (SLDB). Periodically the SLDB is referenced by the Signature Mapping Engine (SMEN) for the purpose of updating the Signature Database—a database used to estimate the location of subscribers. To the extent that “spheres and hyperplanes” (requiring one and two satellites, respectively) are more readily acquired indoors than 2D fixes (requiring three satellites), this framework enables the faster, cheaper compilation of a market-ready Signature Database, improving coverage as well as accuracy. Furthermore, the enlistment of subscribers in the compilation of the database ensures that once up and running, the database will be maintainable at modest cost.

Instead of performing the compute-intensive (and therefore battery depleting) signal processing task at the point of measurement, it is performed offline, where powerful servers are available to implement sophisticated (and generally more compute-intensive) signal processing techniques to maximize the processing gain, reducing the minimum signal strength required to acquire a GPS satellite, and leveraging further the thesis articulated above. One such technique looks to large datagrams (recordings of the composite GPS signal) as, the means to improve signal processing gain. This technique has recently become practical (cf. pending U.S. patent application Ser. No. 12/587,096 and Ser. No. 12/587,099) with the application of a perfect reference (see below).

In the MDLS of FIG. 2a, the measurements used to build the AP Survey Database are presumed to include time-stamped recordings of GPS data (also referred to as a datagram) together with the ID's and received signal strength indicators (RSSI's) of any AP's detectable by the measuring instrument, which may be a subscriber's mobile device. The time-stamp is included as a cue to assist in the processing of GPS signals, and need not be precise. These measurements are processed by GPS Signal Processor (GPSP) to extract as many as three surfaces of location (where four or more satellite signals of sufficient strength are present). For the purposes of illustration, assume that these surfaces are hyperplanes. If two satellite signals of sufficient strength are present, one hyperplane of location will be extracted; if three, two hyperplanes will be extracted. The extracted hyperplanes are then catalogued by Signature, in the Surfaces of Location Database.

As indicated, the Signature Mapping Engine (SMEN) constructs/maintains the Signature Database. For each Signature, a proxy location is constructed utilizing the associated surfaces of location. The Signature Database thus becomes a directory indexed on wireless signatures, with a wireless signature consisting of a list of access points together with their associated received signal strengths, and the directory associating with each signature a location, which is derived from surfaces of location measured at different times using different measuring instruments. The task of the Subscriber Device Location Engine (SLEN), which estimates the location of subscribers, is thus reduced to a search of the Signature Database for the wireless signature or signatures closest to the subscriber-supplied signature, and interpolating between the associated locations.

There are many possible metrics available to measure closeness, when the subscriber-supplied signature cannot be found in the Signature Database. A “distance metric” could be constructed to measure the closeness of two signatures. One or more “acceptance criteria” (e.g., the number of wireless access points in common) could be applied to insure the integrity of the “distance metric”.

An alternative approach to the construction of the Signature Database is to begin with a comprehensive catalogue of wireless signatures. Working through this catalogue, signature by signature, the SMEN first assembles a relevant set of unique hyperplanes for use in estimating the location corresponding to the signature in question. In the ideal case, the Surfaces of Location Database contains several unique hyperplanes whose signatures match identically the signature in question, in which case, the choice is simple: the relevant set is comprised of those unique hyperplanes whose signatures match that provided by the subscriber.

Having constructed a relevant set of hyperplanes, SMEN proceeds to determine the point closest to those hyperplanes comprising the relevant set. A common technique is to determine the point for which the weighted sum of the squares of the distances from said point to the hyperplanes of the relevant set is minimized.

As an aside, it is important to note that the minimization of the sum of the squares of the distances to hyperplanes, for example, is but one of many objective functions, contemplated in the present invention, for minimizing subscriber location estimation error. Another well-known objective function is min/max, wherein the maximum distance from the estimated location to the surfaces of hyperplanes is, minimized. Simple modifications to the foregoing would be to weight the measurements within the minimization. Numerous weightings (e.g., relative signal strength, age of measurement, etc.) are available to enable high quality estimates.

Absent the ideal case, the choice of relevant hyperplanes involves the use of a “distance metric” with an “acceptance criteria”. The metric would allow signature comparison, and the criteria would determine the permitted variance from the ideal. It should be noted that the minimum number of hyperplanes required to estimate a subscriber's location is two, as SMEN applies a pseudo satellite at the earth's center to assure that reasonable estimates are obtained even when measurements are sparse.

In accordance with this invention, a method for estimating the location of a mobile Wi-Fi signal receiver from a database of independently obtained survey data; i.e., survey data measured at different times, in different places, and with different instruments, is disclosed. Each survey datum includes a surface of location derived from a composite GPS signal, together with a Wi-Fi signature measured concurrently with the GPS signal measurement, at some point on said surface of location. The method comprises receiving a Wi-Fi signature, measured and recorded by said mobile Wi-Fi signal receiver, at the location to be estimated; extracting from the database, an algorithmically-determined subset of surfaces of location, utilizing the Wi-Fi signature recorded by said mobile Wi-Fi signal receiver, and estimating the location of said mobile Wi-Fi signal receiver from said algorithmically-determined subset of surfaces of location.

In one embodiment, the algorithmically-determined subset consists of those surfaces of location with Wi-Fi signatures identical to the mobile Wi-Fi signature; and the estimate of the location of said mobile Wi-Fi signal receiver is determined as the point for which the sum of the squares of the distances to each of the surfaces of location included in said algorithmically-determined subset is minimized.

Also disclosed is a system for building a database of Wi-Fi signatures, each with an associated location within a geographical area of interest, said system comprising:

one or more mobile Wi-Fi database-building devices, each having a GPS receiver and a Wi-Fi signal transceiver;
a survey process, whereby each of said one or more mobile Wi-Fi database-building devices, operating within said geographical area of interest, periodically measures and records a time-stamped composite GPS signal, hereinafter referred to as the GPS datagram, together with the identifiers and signal strengths of any Wi-Fi access points detectable by said mobile Wi-Fi database-building device, the set of access point identifier/signal strength pairs hereinafter referred to as a Wi-Fi signature;
GPS signal processing means for deriving, from each GPS datagram, the start-of-transmission and the time-of-arrival (TOA) from, and implicitly the distance to, each acquirable GPS satellite:
spherical surface of location derivation means for deriving a spherical surface, centered on an acquired satellite, at a prescribed distance from the point of measurement;
spherical surface of location database means for storing spherical surfaces of location, together with their associated Wi-Fi signatures;
Wi-Fi signature location estimation means for estimating, from spherical surfaces of location sharing a common Wi-Fi signature, the approximate location of the one or more mobile Wi-Fi database-building devices at such times as said common Wi-Fi signature was measured and recorded; and
Wi-Fi signature database means for storing Wi-Fi signatures, together with their associated estimates of location.

In one embodiment of the foregoing system, the GPS signal processing means derives the distances to acquired satellites from GPS datagrams spanning multiple cycles of GPS' 50 Hz data overlay, extending processing gain to its practical limit.

In another embodiment, the GPS signal processing means uses a perfect reference, to enable efficient processing of large GPS datagrams.

Those skilled in the art will understand that the methods and apparatus of the present invention may be applied to satellite positioning systems evolved from the GPS satellite positioning system, including but not limited to the Galileo and Glonass systems.

Various aspects and features of the present invention may be understood by examining the drawings here listed.

### BRIEF DESCRIPTION OF THE DRAWINGS

FIG. 1 shows a system diagram of a prior art mobile device location system (MDLS)

FIG. 2a shows a system diagram of an MDLS employing the present invention

FIG. 2b shows a system diagram of an MDLS employing the present invention

FIG. 3 describes the data structure transmitted by a GPS satellite

FIG. 4 illustrates the nature of path losses experienced by satellite signals penetrating commercial buildings

FIG. 5 shows a block diagram of a prior art GPS receiver

FIG. 6 shows a block diagram of a prior art assisted-GPS receiver

FIG. 7 describes the output of a correlator

FIG. 8 describes the output of a correlator

FIG. 9 describes the output of a correlator

FIG. 10(a) describes a robust GPS assistance system

FIG. 10(b) describes a robust GPS assistance system

FIG. 11 shows a block diagram of a thin GPS client used in a thin-client implementation of a GPS signal processing system employing the present invention

FIG. 12 shows a block diagram of a GPS server used in a thin-client implementation of a GPS signal processing system employing the present invention

FIG. 13 shows a block diagram of a GPS server used in a thin-client implementation of a GPS signal processing system employing the present invention

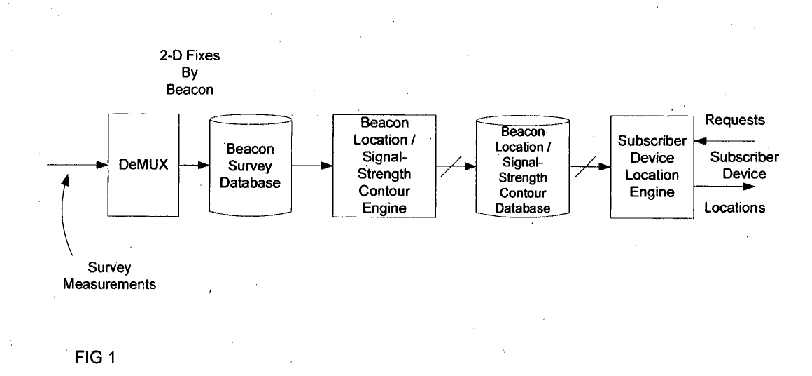

### DETAILED DESCRIPTION OF THE INVENTION

In general, the object of the present invention is to provide an MDLS framework to enable the rapid and inexpensive compilation and maintenance of a comprehensive AP Survey Database, to support the location of subscribers with the accuracy and efficiency required by current and contemplated location-based applications. As the repository for field measurements, applied ultimately to estimate the locations of subscribers' mobile devices, the AP Survey Database influences virtually every metric of importance to the operators as well as the subscribers of location services. Coverage must be complete; measurements must be easily and efficiently obtained, using accurate but inexpensive instruments. And the real-time computation associated with estimating subscriber locations with acceptable accuracy must be manageable.

The framework of mobile device location systems in use today are built on Beacon Survey Databases constructed with the aid of 2D GPS fixes. Estimates of subscriber location are then derived using cues (beacon ID's, signal strengths) supplied by the subscriber's mobile device. While cell-tower-based systems provide excellent coverage, the accuracy indoors is generally unacceptable. Access-point-based systems, with the potential for significantly improved accuracy, have yet to demonstrate their viability, owing to the cost of developing and maintaining the AP Survey Database.

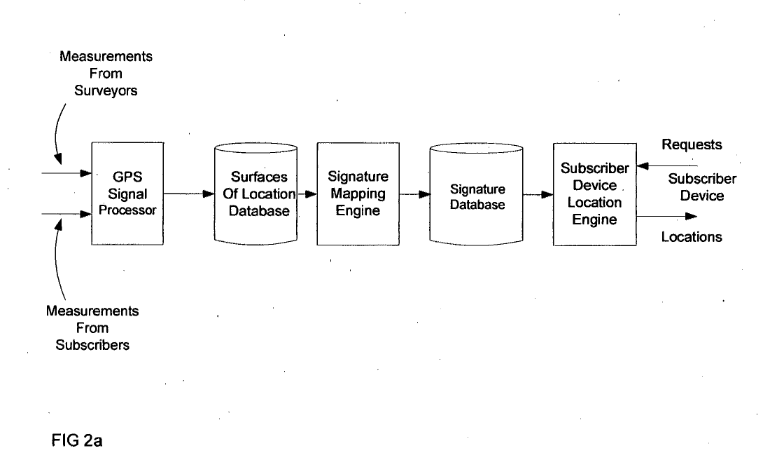

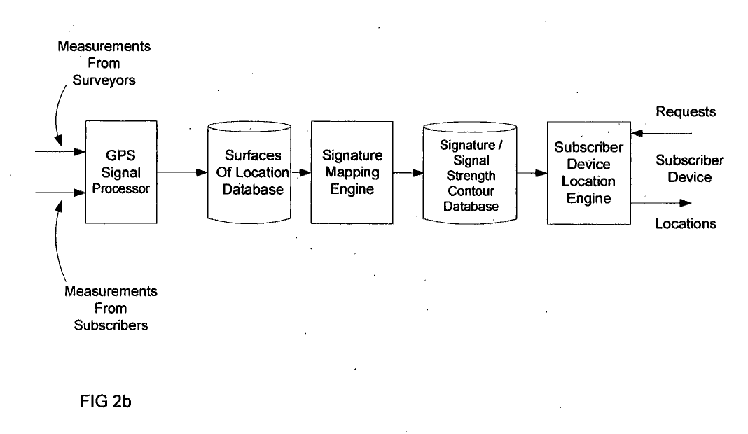

To address the challenges facing today's access-point-based systems, a new MDLS framework (FIG. 2a) is disclosed. While the proposed framework bears a resemblance to the framework of today's MDLS, it is conceptually quite different. On the surface, an obvious difference is the replacement of the AP Survey Database with the Surfaces of Location Database (SLDB), and the Beacon Location/Signal-Strength Contour Database with a Signature Database (SGDB). The principal difference, however, flows from the underlying thesis that “imperfect”. GPS data recordings—recordings which fail to yield sufficient information to generate a 2D GPS fix—collected indoors, can provide the foundation for an effective access-point-based MDLS. This thesis, underlying the proposed framework, affects the measurement process as follows: Instead of recording a 2D GPS fix together with the ID's and signal-strengths of AP's detectable by the measuring instrument, GPS data are recorded at different times and different places using different instruments, without regard for the ability of the data to yield a 2D GPS fix. The subsequent processing of the recorded GPS data, for the purpose of estimating subscriber location, is detailed in the description of an MDLS implementation of this thesis (see below).

A convenient corollary of this thesis is that it enables the enlistment of subscribers in the measurement process. Under the existing framework(s), subscribers do not participate in the measurement process, requesting location services when GPS has failed to yield a 2D fix. Under the proposed framework, a request for location service could include GPS data (even though GPS has failed to produce a 2D fix), along with the ID's and signal strengths of any AP's detectable by the subscriber's mobile device. (To the extent a subscriber supplies any information for the purpose of obtaining his or her location, he or she has voluntarily disclosed his or her location; hence the proposed enlistment introduces no issues of privacy.)

Finally, this thesis and the resulting framework favor a thin-client implementation, which, in turn, enables the application of sophisticated signal processing techniques to reduce significantly the minimum signal strength required to acquire GPS satellites indoors.

FIG. 2a illustrates the thin-client approach to the extraction of GPS satellite signals from the composite GPS signal. The GPS measurement data input to the MDLS consists of the composite GPS signal for processing offline, rather than a 2D fix as is the case in today's MDLS. Moreover, instead of compiling a database of AP locations from 2D fixes, the proposed framework envisions a database of wireless signatures for use in locating subscribers directly. The GPS Signal Processor (GPSP) extracts surfaces of location (e.g., spheres and hyperplanes) which are catalogued by signature (a signature being the set of AP's detected at the point of measurement together with their associated signal strengths) in the Surfaces of Location Database (SLDB). Periodically the SLDB is referenced by the Signature Mapping. Engine (SMEN) for the purpose of updating the Signature Database—a database used to estimate the location of subscribers. To the extent that “spheres and hyperplanes” (requiring one and two satellites, respectively) are more readily acquired indoors than 2D fixes (requiring a minimum of three satellites), this framework enables the faster, cheaper compilation of a market-ready Signature Database, improving coverage as well as accuracy. Furthermore, the enlistment of subscribers in the compilation of the database ensures that once up and running, the database will be maintainable at modest cost.

Instead of performing the compute-intensive (and therefore battery depleting) signal processing task at the point of measurement, it is performed offline, where powerful servers are available to implement sophisticated (and generally more compute-intensive) signal processing techniques to maximize the processing gain, reducing the minimum signal strength required to acquire a GPS satellite, and leveraging further the thesis articulated above. One such technique looks to large datagrams (recordings of the composite GPS signal) as the means to improve signal processing gain. This technique has recently become practical (cf. pending U.S. patent application Ser. No. 12/587,096 and Ser. No. 12/587,099) with the application of a perfect reference (see below).

In the MDLS of FIG. 2a, the measurements used to build the Surfaces of Location Database are presumed to include time-stamped recordings of GPS data (also referred to as a datagram) together with the ID's and received signal strength indicators (RSSI's) of any AP's detectable by the measuring instrument, which may be a subscriber's mobile device. The time-stamp is included as a cue to assist in the processing of GPS signals, and need not be precise. These measurements are processed by GPS Signal Processor (GPSP) to extract as many as three surfaces of location (where four or more satellite signals of sufficient strength are present). For the purposes of illustration, assume that these surfaces are hyperplanes. If two satellite signals of sufficient strength are present, one hyperplane of location will be extracted; if three, two hyperplanes will be extracted. The extracted hyperplanes are then catalogued by Signature, in the Surfaces of Location Database.

As indicated, the Signature Mapping Engine (SMEN) constructs/maintains the Signature Database. For each Signature, a proxy location is constructed utilizing the associated surfaces of location. The Signature Database thus becomes a directory indexed on wireless signatures, with a wireless signature consisting of a list of access points together with their associated received signal strengths, and the directory associating with each signature, a location, which is derived from surfaces of location measured at different times using different measuring instruments. The task of the Subscriber Device Location Engine (SLEN), which estimates the location of subscribers, is thus reduced to a search of the Signature Database for the wireless signature or signatures closest to the subscriber-supplied signature, and interpolating between the associated locations.

There are many possible metrics available to measure closeness, when the subscriber-supplied signature cannot be found in the Signature Database. A “distance metric” could be constructed to measure the closeness of two signatures. One or more “acceptance criteria” (e.g., the number of wireless access points in common) could be applied to insure the integrity of the “distance metric”.

An alternative approach to the construction of the Signature Database is to begin with a comprehensive catalogue of wireless signatures. Working through this catalogue, signature by signature, the SMEN first assembles a relevant set of unique hyperplanes for use in estimating the location corresponding to the signature in question. In the ideal case, the Surfaces of Location Database contains several unique hyperplanes whose signatures match identically the signature in question, in which case, the choice is simple: the relevant set is comprised of those unique hyperplanes whose signatures match that provided by the subscriber.

Having constructed a relevant set of hyperplanes, SMEN proceeds to determine the point closest to those hyperplanes comprising the relevant set. A common technique is to determine the point for which the weighted sum of the squares of the distances from said point to the hyperplanes of the relevant set is minimized.

As an aside, it is important to note that the minimization of the sum of the squares of the distances to hyperplanes, for example, is but one of many objective functions, contemplated in the present invention, for minimizing subscriber location estimation error. Another well-known objective function is min/max, wherein the maximum distance from the estimated location to the surfaces of hypeiplanes is minimized. Simple modifications to the foregoing would be to weight the measurements within the minimization. Numerous weightings (e.g., relative signal strength, age of measurement, etc.) are available to enable high quality estimates.

Absent the ideal case, the choice of relevant hyperplanes involves the use of a “distance metric” with an “acceptance criteria”. The metric would allow signature comparison, and the criteria would determine the permitted variance from the ideal. It should be noted that the minimum number of hyperplanes required to estimate a subscriber's location is two, as SMEN applies a pseudo satellite at the earth's center to assure that reasonable estimates are obtained even when measurements are sparse.

In addition to its primary role; namely, to refresh the Signature Database as new surfaces of location are acquired, SMEN is uniquely positioned to assume a quality assurance role. With access to the Signature Database, SMEN can spot anomalies in the Signature data and isolate “corrupted” hyperplanes in the SLDB.

While a database of wireless signatures is conceptually quite different than a database of AP locations, the proposed framework has a number of similarities with today's MDLS. Whether the beacons are cellular towers or wireless access points (or the beacon of the future)—the proposed measurement processes are largely identical. As with the existing framework, the measuring instruments employed are similar, if not identical, to the mobile communications devices which the MDLS has been designed to locate. The standard mode of operation is modified, but slightly; namely, to traverse the geography of interest with the instrument, pausing periodically to record GPS data (rather than 2D fixes) together with the ID's and signal-strengths of any beacons detectable by the instrument. It is at the point that the processing of the measurements begins that the frameworks diverge dramatically. In the proposed framework, the GPS data are processed offline, as it were, with a resulting improvement in sensitivity achieved through the use of advanced signal processing technology (see below). The output of the signal processor is a surface of location (rather than a fix), which forms the Surfaces of Location Database. In another departure from today's MDLS, the subscriber's mobile device (assuming on-board GPS) serves as an instrument in the ongoing measurement process.

### Signal-Strength Contours Applied to Subscriber Device Location

While a database of wireless signatures provides a foundation for providing more accurate estimates of subscriber device location, the improvement in accuracy depends on the resolution of signal strength measurements. Where signal strength measurements are relatively coarse, and the incidence of overlapping wireless coverage is high, it may be appropriate to compile a Signal-Strength Contour Database from the Signature Database, enabling the use of signal-strength-contour intersection techniques in lieu of or in addition to the signature matching techniques, enumerated in a previous paragraph. FIG. 2b describes a framework incorporating a hybrid Signature/Signal-Strength Contour Database (SCDB). SCDB may be implemented by simply expanding the functionality of SMEN (of FIG. 2a) to include the aggregation of all wireless signature locations associated with a given access point/signal strength pair into a signal-strength contour point set; fitting the points of the set with a non-self-intersecting curve; and storing the resulting curve, together with the associated access point/signal strength pair in the Signature Database (of FIG. 2a). To avoid topological anomalies, curves constructed to “fit” signal-strength contour point sets aggregated around a common access point must not intersect. While on the surface, the task of constructing usable contours may appear formidable, the art is well developed, considering the available insight into signal-strength behavior in the vicinity of wireless access points, and the limited precision required of signal-strength contours to assure the accurate estimation of subscriber device location.

To exploit the availability of these signal-strength contours, the functionality of SLEN would necessarily be expanded to include 1) logic to choose between signature matching and signal-strength-contour intersection techniques, based on the attributes of the subscriber-supplied wireless signature, and 2) an algorithm to estimate the location of the subscriber device using signal-strength contours. In an example of the former, signal-strength contour intersection is chosen if the number of available contours “fit” to sets of 10 or more points is 3 or more; signature matching, if less than 2. In an example of the latter, the estimate of the subscriber device is determined as the point for which the sum of the squares of the distances to each of the signal-strength contours is minimized.

### Recording GPS Data

As indicated above, GPS data can be recorded in a variety of formats, varying from perhaps the most compact format, a 2D GPS fix, to perhaps the least compact format, a digitized recording of the composite GPS signal. In between are numerous possibilities, from the start-of-transmission and the time of arrival (TOA) of a transmission from an identified GPS satellite, to the start-of-transmission for each of two identified GPS satellites, together with the difference in their times of arrival (TDOA).

Mindful that the objective is to map wireless signatures, where the availability of a 2D GPS fix is a rarity, we are compelled to examine other possibilities. If, instead of 2D fixes, measurements are taken at different times and in different places, and with each measurement, the recorded GPS data includes the start-of-transmission and the TOA (measured from the start-of-transmission) from identified GPS satellites, the effect would be to generate spheres of location, centered on the identified satellites, each with radius equivalent to the (computed) distance to said satellite. While the actual 2D locations of these measurements would forever be unknown, the general locations of these measurements would be known by the spheres on whose surfaces they lie. Given an ensemble of spheres each with the same wireless signature, the mapping (or location) of said signature could be accomplished by determining the point for which the sum of the squares of the distances to the surfaces of the associated spheres is minimized. (This approach is equivalent to determining the point for which the sum of the squares of the errors in the associated TOA's is minimized.) In this case, all that is needed is one (not three) acquirable satellites per measurement—and an accurate clock, to measure TOA's. It should be noted that the accuracy required of the clock is severe, and in the general case may make single-satellite measurements impractical. In the special case, where four or more satellites (and, implicitly, an accurate clock) are available, one to three TOA's could be recorded, depending on the extent to which privacy considerations may impose a limit on the amount of third-party location information accessible to a location service provider.

To get around the requirement for an accurate clock, another alternative is available, requiring two acquirable satellites. Consider the case in which measurements are taken at different times and in different places, and with each measurement, the recorded GPS data includes the start-of-transmission for each of two identified satellites, together with the TDOA, the effect would be to generate hyperplanes of location, each with its apex on, and its axis collinear with, the line joining the two identified satellites. If a third satellite were acquirable, and the difference in its time of arrival relative to that of either of the first two satellites were measured, the effect would be to generate two hyperplanes of location for that measurement. While the actual 2D locations of these measurements would forever be unknown, the general locations of these measurements would be known by the hyperplanes on whose surfaces they lie. Given an ensemble of hyperplanes each with the same wireless signature, the mapping (or location) of said signature could be accomplished by determining the point for which the sum of the squares of the distances to the surfaces of the hyperplanes is minimized. Alternatively, the location of the signature may be estimated by determining the point for which the sum of the squares of the errors in the associated TDOA's is minimized. However the estimate is derived, the measurements employed require a minimum of two acquirable satellites—and an ordinary clock.

The simplest approach is to record the composite GPS signal, together with the ID's and signal strengths of any AP's detectable by the instrument/device, and extract the available satellite signals offline. The disadvantage of this approach (occurring when a subscriber device operates as a measurement device) is the bandwidth utilized to transmit the GPS data (also called the datagram); the advantage is the potential to apply sophisticated signal processing techniques to decode long datagrams (hundreds of milliseconds in length), and enhance further the sensitivity of GPS receivers (see below). Using powerful servers, spheres (times of arrival) and hyperplanes (differences in times of arrival), invisible to commodity GPS receivers, are extracted from the datagrams, and posted to the Surfaces of Location Database.

### GPS Signals and Signal Processing Technique

The signals from all GPS satellites are broadcast synchronously, using the same carrier frequency, 1.57 GHz in the case of the NAVSTAR system. However, each satellite has a unique identifier, or pseudorandom noise (PRN) code having 1023 chips, thereby enabling a GPS receiver to distinguish the GPS signal from one GPS satellite from the GPS signal from another GPS satellite. In addition, each satellite transmits information allowing the GPS receiver to determine the exact location of the satellite at a given time. The GPS receiver determines the distance (pseudo range) from each GPS satellite by determining the time delay of the received signal. Given the exact locations and the pseudo ranges, the estimation of 2D location coordinates can be accomplished with as few as two satellite pseudo ranges, provided they have been measured using an accurate time reference. Since this is impractical with current GPS navigational platforms, the computation of 2D location coordinates is generally accomplished using three pseudo ranges. Once the pseudo ranges for at least three GPS satellites have been determined, it is a straightforward process to determine the location coordinates of the GPS receiver.

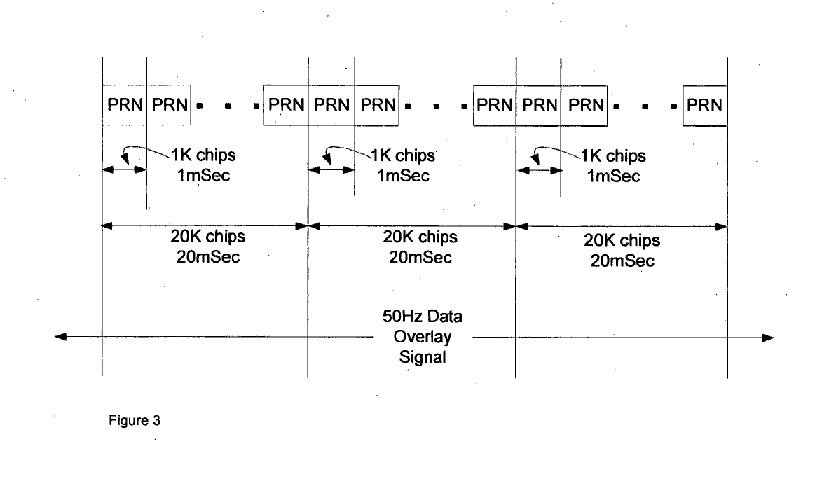

FIG. 3 describes the data structure of the signal that is broadcast by each GPS satellite; as illustrated, the signal consists of a 50 Hz data overlay signal—20 millisecond data bits—modulating a one millisecond PRN code interval of 1023 bits or chips. The PRN code is known as a spreading code because it spreads the frequency spectrum of the GPS signal. This spread spectrum signal is known as a direct sequence spread spectrum (DSSS) signal.

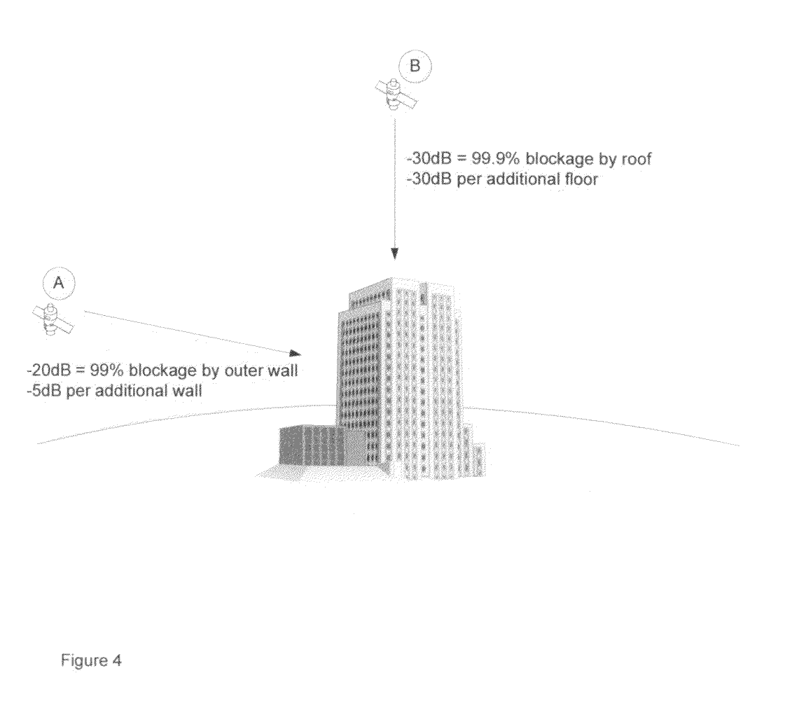

Indoors, satellite signals suffer severe path losses as they are forced to penetrate windows, walls, and ceilings enroute to the receiver. Commercial buildings, in particular, introduce severe path losses (FIG. 4). Along the vertical, the roof and each intermediate floor contribute losses of estimated at 30 db. Exterior walls provide an estimated loss of 20 db, with interior walls adding 5 db each. Clearly, the indoor environment favors satellites near the horizon (over those directly above).

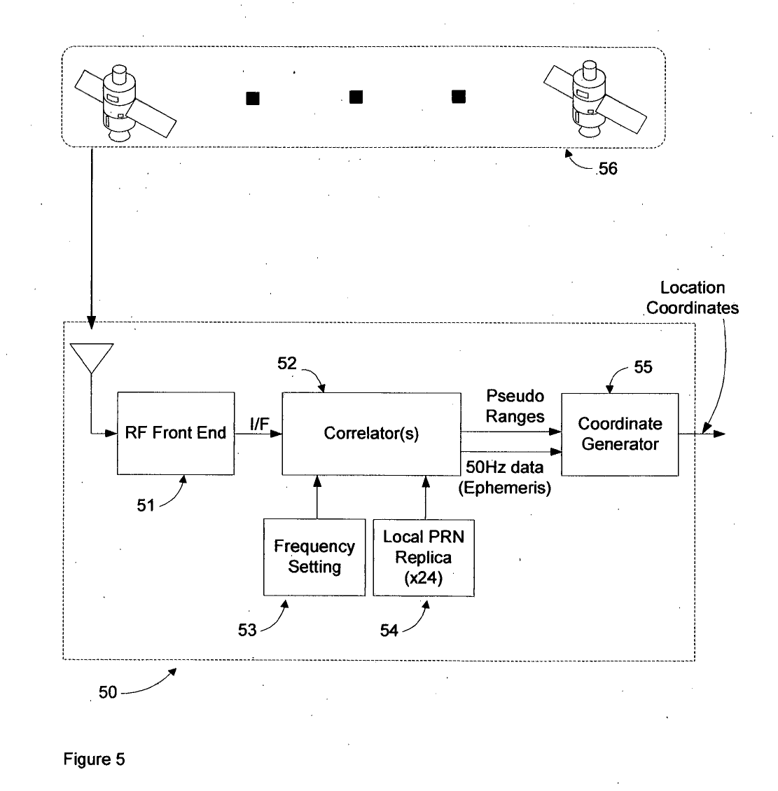

FIG. 5 illustrates a block diagram of a prior art GPS receiver. The GPS signal from GPS satellite constellation 56 is received by the R/F front end 51 of GPS receiver 50. R/F front end 51 down converts the 1.57 GHz R/F signal, resulting in an intermediate frequency (I/F) signal. The streaming I/F signal is examined by a correlator or bank of correlators 52, employing a search algorithm to confirm the presence or absence, within the composite GPS signal, of the uniquely coded signals from the GPS satellites. In a typical search algorithm, the local frequency 53 is scanned across a range of frequencies; for each frequency, a series of correlations involving the incoming GPS signal and all possible code phases of a local replica 54 of the designated satellite's PRN code are used to “acquire” the designated satellite (i.e., establish the presence of the designated satellite signal within the composite GPS signal). In order to ensure that the correct code phase is not missed due to local clock off-set, it is conventional to increment the local replica code phase in one-half chip or even smaller steps. The granularity of these steps is limited by the amount of over sampling that is performed on the incoming I/F signal. A high correlation peak value indicates that the designated satellite is present, and its signal, decodable. If no correlations peaks are high enough, the local frequency 53 is set to a second trial frequency and the correlations are repeated. Once pseudo range information has been obtained for at least three GPS satellites along with the corresponding satellite timing information, the coordinate generator 55 determines the two-dimensional location coordinates of GPS receiver 50.

To obtain a first fix, GPS receiver 50 must (1) acquire a minimum of three GPS satellites by tuning the local frequency 53 and the code phase of the local PRN code replica 54 in the GPS receiver to match the carrier frequency and the PRN code phase of each of the electronically visible (i.e., decodable) satellites. The search for correlation peaks of sufficient strength to enable the extraction of reliable pseudo range information is a time-consuming process, and failure-prone in indoor and urban canyon environments.

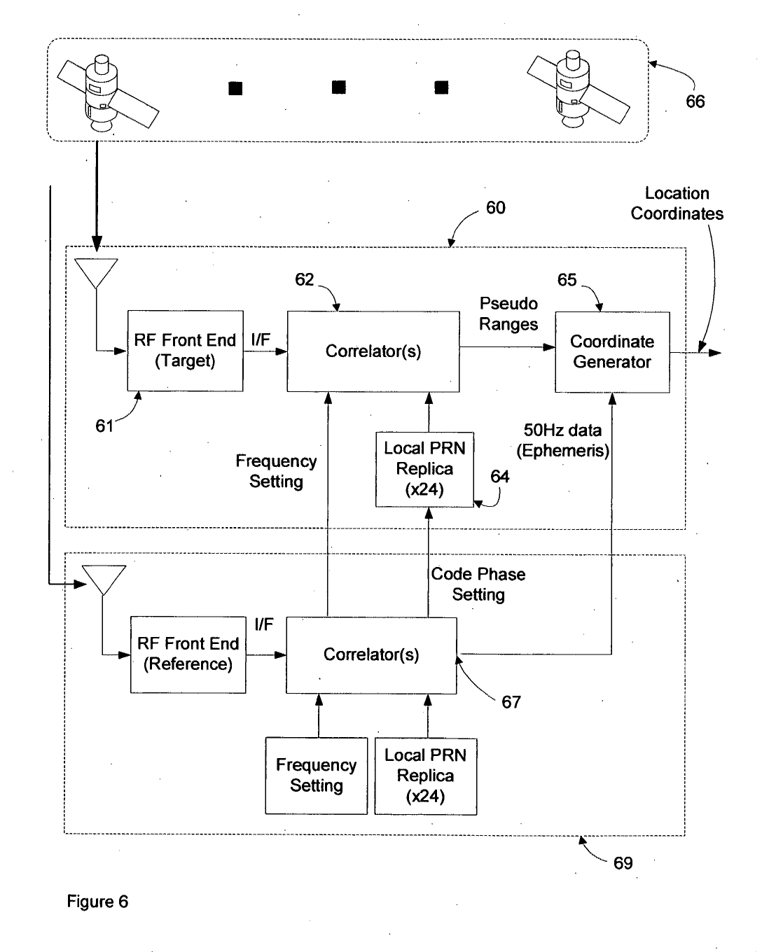

To minimize the time to first fix (TTFF) of GPS receivers such as GPS receiver 50, the concept of a GPS assistance system has been introduced (see FIG. 6). The role of GPS assistance system 69 is to track the satellites electronically visible at the site of GPS assistance system 69, and provide assistance, in the form of carrier frequency and PRN code phase information to GPS receiver 60 in the vicinity of GPS assistance system 69. As in the case of GPS receiver 50, the GPS signal from GPS satellite constellation 56 is received by the R/F front end 61 of GPS receiver 60. R/F front end 61 down converts the 1.57 GHz R/F signal, resulting in an intermediate frequency (I/F) signal. The streaming I/F signal is examined by a correlator or bank of correlators 62, which is used to acquire satellites. To expedite the acquisition process, carrier frequency and PRN code phase information derived by GPS assistance system 69, in the course of tracking acquirable satellites, is transmitted to GPS receiver 60. This information is used to initialize the search algorithm, enabling the algorithm to operate more efficiently and more effectively. As a result the TTFF is significantly reduced, and receive sensitivity is improved marginally, to the extent that information provided enables the acquisition of satellites otherwise electronically invisible (that is to say, their signals are not decodable) to GPS receiver 60. Once pseudo range information has been determined for three GPS satellites, the location coordinates are determined by coordinate generator 65.

Care must be taken in the generation of GPS assistance data, to insure the integrity of data for satellites at or near the horizon, as these may be the satellites most visible indoors. If GPS assistance data are generated from GPS signals taken in the clear, for example, strong overhead satellite signals could compromise the integrity of GPS assistance data generated for weaker satellites, for example, satellites at or near the horizon.

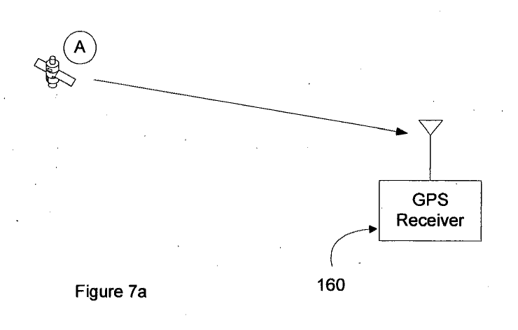

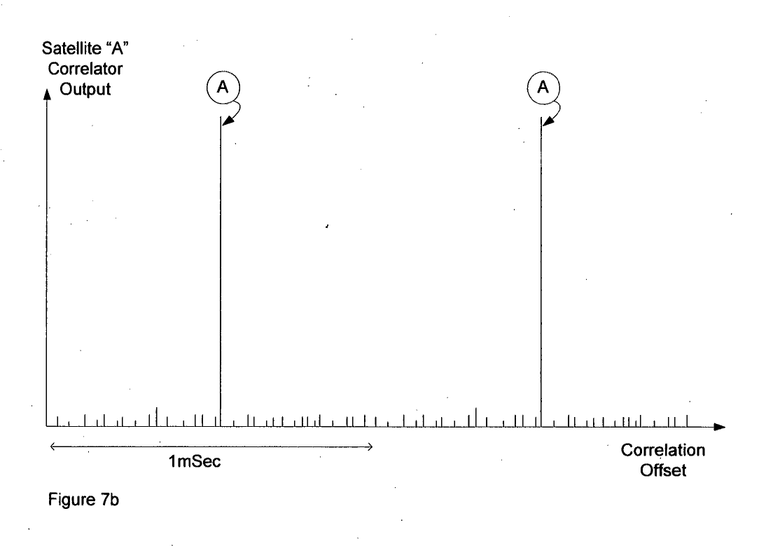

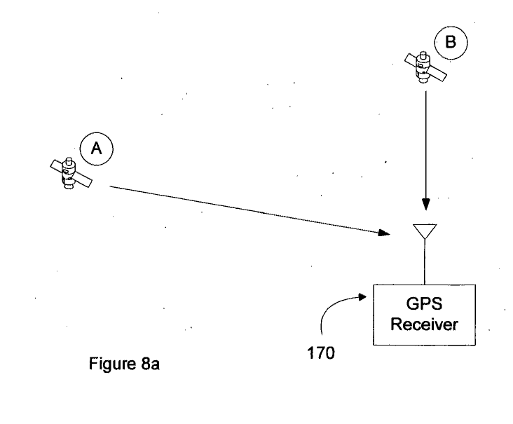

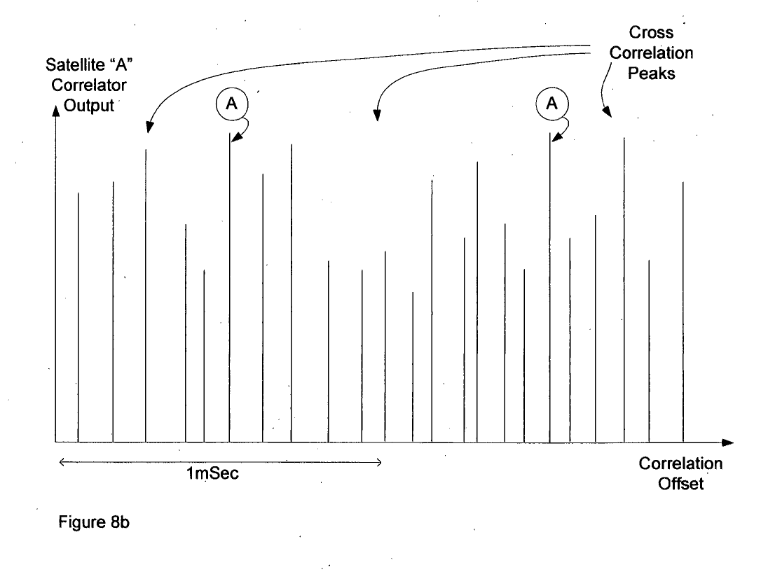

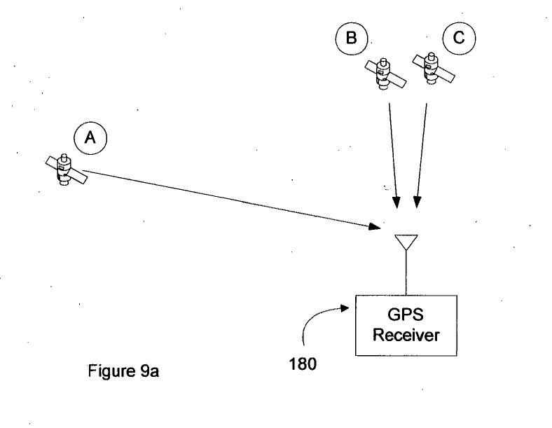

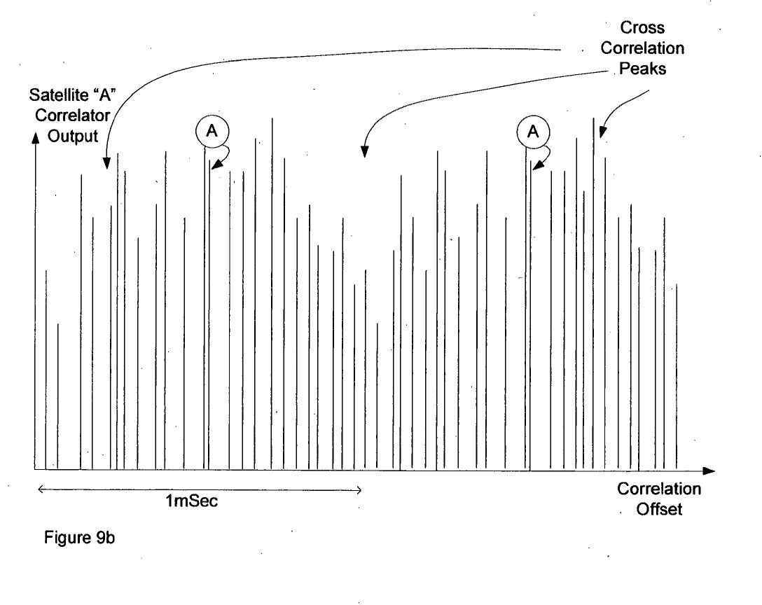

The potential for strong satellite signals to interfere in the tracking of weak satellite signals is an artifact of the correlation process which serves as the foundation for GPS satellite signal acquisition and tracking techniques. This is illustrated in FIGS. 7-9. FIG. 7 describes the output of the correlation of the composite GPS satellite signal with the PRN code for weak satellite A, as it would appear if all other GPS satellites were turned off. A distinct peak in the correlator output marks the presence of (a signal from) satellite A. In FIG. 8, strong satellite B has been turned on, and the output of the correlator has changed, revealing prominent cross correlation peaks owing to the relative strength of (the signal from) satellite B. In FIG. 9, a second strong satellite C has been turned on, adding additional prominent cross correlation peaks to the correlator output. These figures illustrate how the search for the autocorrelation peak corresponding to weak satellite A is complicated, if not completely frustrated, by the prominent cross correlation peaks introduced by the strong satellites B and C.

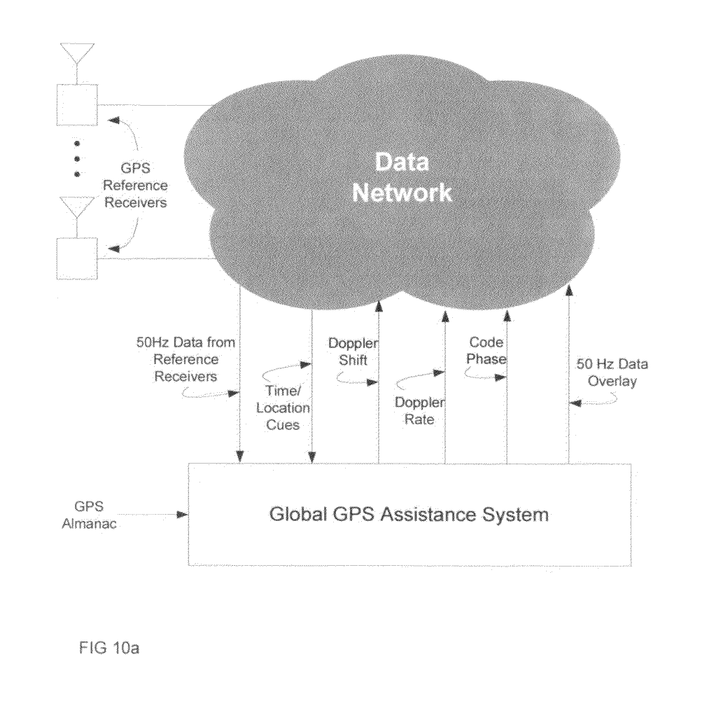

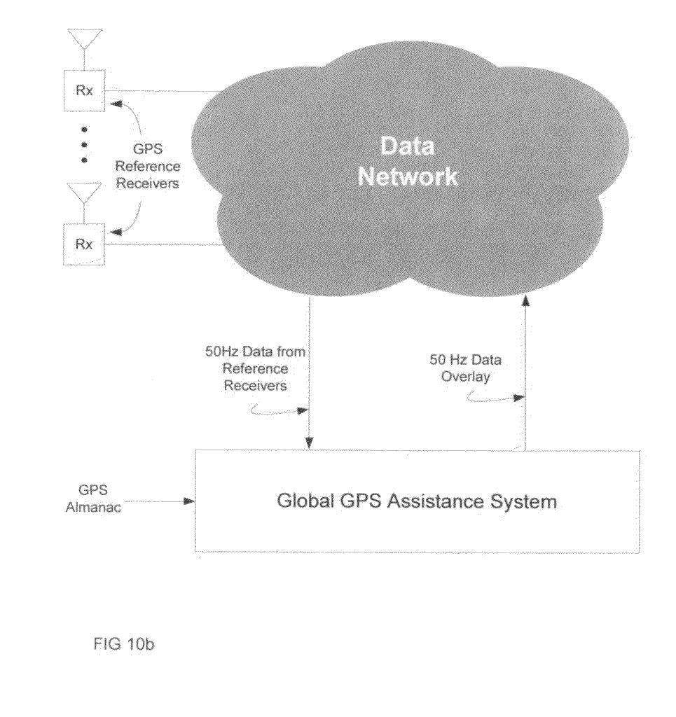

To insure the integrity of GPS assistance data for weak or overpowered satellites, exemplified by those at or near the horizon, a global alternative to GPS assistance system 69 is proposed. One embodiment of this Global GPS Assistance System (GGAS) is described in FIG. 10a. GGAS is the hub of a world-wide GPS assistance service in which GPS receivers such as GPS receiver 60 are client-subscribers. By deploying a number of GPS receivers strategically around the globe, each of the 24-32 satellites are tracked without strong-signal interference, contributing to a more robust GPS assistance system. The 50 Hz data overlay from each of the satellites, recorded at the globally deployed GPS receivers, is assembled and forwarded (to client GPS receivers) from GGAS. In addition, GPS almanac information is applied to generate Doppler shift and code phase offset information in response to client-supplied time and location cues. Note that the GPS assistance data provided by the GGAS of FIG. 10a includes the rate of change of the carrier frequency (Doppler rate), as well as the shift in carrier frequency (Doppler shift), code phase offset, and the 50 Hz data steam, for each potentially acquirable satellite.

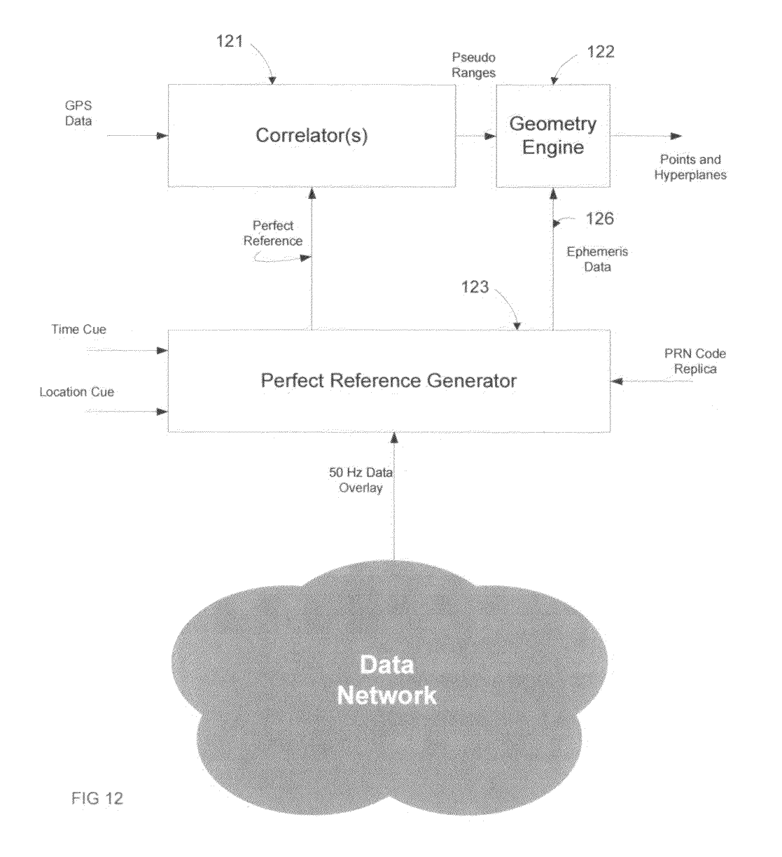

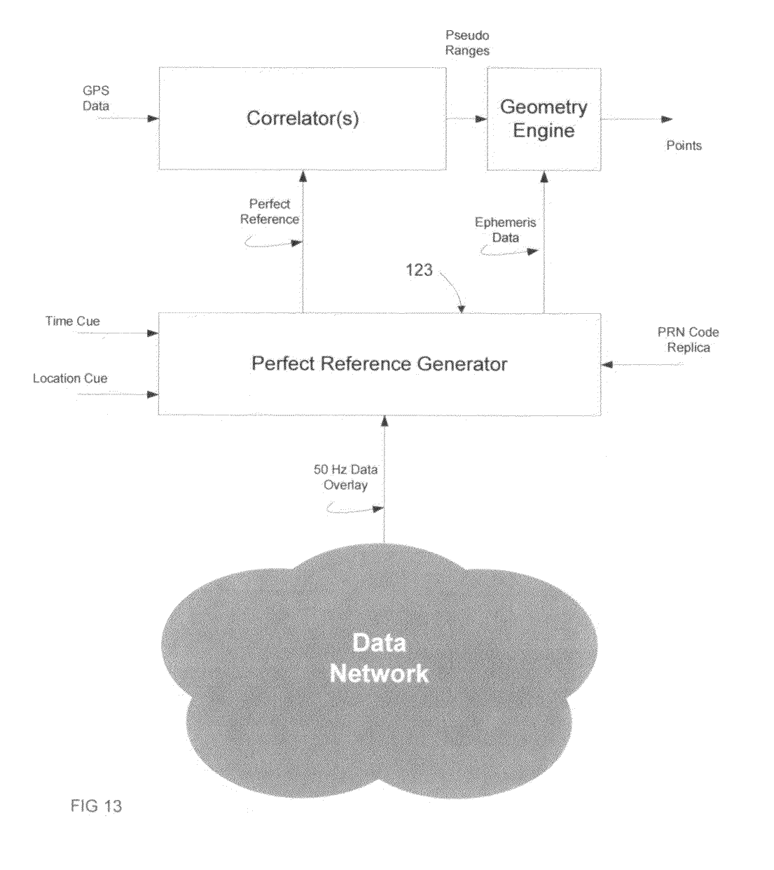

FIG. 10b describes a minimal implementation of the Global GPS Assistance System of FIG. 10a, wherein GPS assistance is provided in the form of continuous 50 Hz data streams for each of the 24 to 32 GPS satellites. The GGAS of FIG. 10b (or any functional superset) may serve as the source of the 50 Hz data streams presumed in FIG. 12.

The utility of GGAS extends beyond conventional thick-client implementations of GPS for sensor location; indeed, GGAS provides an ideal foundation for sophisticated thin-client implementations of GPS for subscriber location, such as the MDLS of FIG. 2a.

### Thin-Client GPS

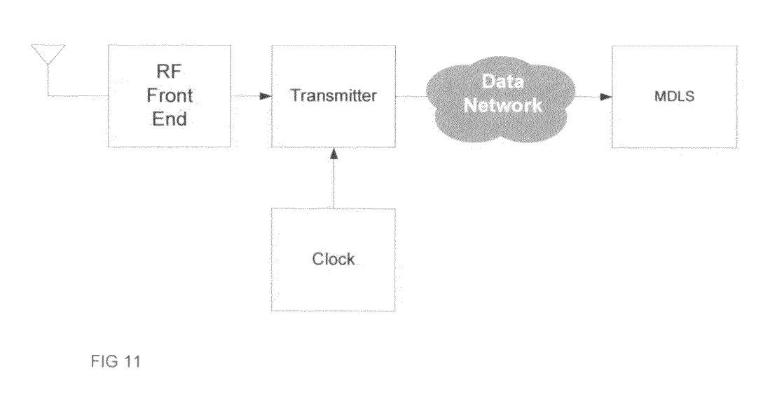

In the compilation of AP Survey Databases utilizing the MDLS of FIG. 2, the GPS client contained in the measuring instrument/mobile device is a minimal subset of the thick client contained in conventional GPS-equipped mobile devices (FIG. 11). All that is required is an antenna, an RF front end, a clock (which need not be precise) and a transmitter to enable measured data to make their way to the MDLS server. Means for deriving a location cue may optionally be incorporated. The server component (GPSP) is more complex. FIG. 12 details one embodiment of the GPSP of FIG. 2.

As described previously, each measurement contains access point information as well as location-related information. In the category of location-related information are the time cue and the GPS datagram. The GPSP of FIG. 12 includes, in addition, a location cue, which requirement may be satisfied by the MDLS itself, via the access point information

As shown in FIG. 12, the GPS data is input to Correlator (or bank of correlators) 121. Correlator 121 correlates the datagram, parsed from the received measurement, with the perfect references for each of the potentially acquirable satellites, to determine pseudo ranges to those satellites. Apart from the fact that the perfect reference substitutes for the carrier frequency setting and PRN code replica, present in prior art, Correlator 121 differs only in its capability to process long datagrams—datagrams spanning one or more cycles of the 50 Hz data overlay. The pseudo ranges are processed by Geometry Engine 122, using ephemeris data 126 extracted by Perfect Reference Generator 123, from the localized 50 Hz data overlay provided by a Global GPS Assistance System. The Geometry Engine of FIG. 12 provides hyperplane output for the estimation of beacon locations, and 2D fixes for the estimation of signal-strength contours. This portion of the datapath is not unconventional.

The unconventional element of the GPSP of FIG. 12 revolves around Perfect Reference Generator (PRG) 123. As the figure shows, the outputs of PRG 123 consist of perfect references for each potentially acquirable satellite to Correlator (or bank of correlators) 121, and ephemeris data 126 to the Geometry Engine 122. Inputs to PRG 123 include a time cue and a location cue, parsed from the received measurement; the streamed 50 Hz data overlay for each of the potentially acquirable satellites, from GGAS; and PRN code replicas, used to generate perfect references for the potentially acquirable satellites.

### The Perfect Reference

To understand the rationale for and operation of PRG 123, consider the impact of the size of a datagram. Correlator 121 and correlators, in general, are better able to detect signals buried in noise when they are able to examine longer datagrams. Signal processing is compute-intensive, and, as a consequence, the limits on the size of datagrams are generally imposed, by limits on available computing resources. Today's thick-client GPS systems are constrained to datagrams of the order of 10 milliseconds. Thin-client implementations, leveraging powerful servers capable of processing datagrams spanning hundreds of milliseconds, open the door to dramatic increases in processing gain, resulting in dramatic reductions in the minimum signal strength required to acquire and track GPS satellites. The key to the efficient realization of dramatic increases in processing gain is the perfect reference.

A Perfect Reference is a waveform representing the signal transmitted by a given satellite (inclusive of its 50 Hz data overlay) as said signal would be observed at a time prescribed by the time cue, and a location prescribed by the location cue. The perfect reference is used to correlate client-supplied GPS data in much the same way as the PRN code replica is used by prior art GPS receivers Using the Perfect Reference constructed fora particular satellite, correlator 121 processes the client-supplied datagram in order to acquire said satellite over periods which can cross multiple low frequency overlay bit boundaries. The resulting processing gain from correlating the client-supplied datagram across multiple bit boundaries has direct bearing on the increased receive sensitivity of GPSP.

The construction of perfect reference waveforms for potentially acquirable satellites is a straightforward process. The first step involves the accurate decoding of the 50 Hz data overlays, enabled by the deployment of GPS receivers so as to insure access to strong signals from each of the GPS satellites. Next, the 50 Hz data overlays are combined with the PRN code replicas for said satellites. Finally, using the satellite positions and trajectories embedded in the 50 Hz data overlays to determine the satellite-specific carrier frequencies, and their rates of change, as well as their relative code phase offsets, in conjunction with the time and optional location cues, the individual waveforms are scaled (in time) and biased to represent the satellite signals as they would be observed at the time and location implicit in the time and location cues.

Accordingly, given a time cue and an optional location cue, the streamed 50 Hz data overlay for each of the potentially acquirable satellites (from GGAS), and PRN code replicas from each of the potentially acquirable satellites, PRG123 generates the perfect references critical to the accurate and efficient extraction of surfaces of location from the received GPS data.

The time cue provides an estimated start time of the GPS data received by the GPS receiver or sensor and the location cue is an estimated location of the receiver. The optional location cue may take the form of coordinates, a wireless access point ID, a cellular base station ID, a ZIP code, or a metropolitan area. The main benefit to using accurate time and location cues is to reduce the amount of computing resources required to process the received GPS data.

We claim:

1. A system for building a database of Wi-Fi signatures, each with an associated Wi-Fi signature location within a geographical area of interest, said system comprising:
one or more mobile Wi-Fi database-building devices, each having a GPS receiver and a Wi-Fi signal transceiver;
a survey process, whereby each of said one or more mobile Wi-Fi database-building devices, operating within said geographical area of interest, periodically measures and records a composite GPS signal concurrently with a Wi-Fi signature comprised of the IDs and associated signal strengths of Wi-Fi access points detectable at the point of measurement;
GPS signal processing means for deriving, from each composite GPS signal, the start-of-transmission and the difference in the times of arrival (TDOA) from a pair of acquirable GPS satellites;
hyperplane of location construction means for constructing, for each pair of acquirable satellites, a hyperplane of location, comprised of points for which the difference between the distance from each point to the positions of each of said pair of acquirable satellites at the start-of-transmission is fixed by the difference in the times of arrival (TDOA);
hyperplane of location database means for storing hyperplanes of location, each with its associated Wi-Fi signature;
Wi-Fi signature location estimation means for estimating, from hyperplanes of location sharing a common Wi-Fi signature, the location of said common Wi-Fi signature, determined as the approximate location of the one or more mobile Wi-Fi database-building devices at such times as said common Wi-Fi signature was measured and recorded; and
Wi-Fi signature database means for storing each Wi-Fi signature, together with its estimated Wi-Fi signature location.

2. The system of claim 1, wherein the time-stamped composite GPS signals span multiple cycles of GPS' 50 Hz data overlay.

3. The system of claim 2, wherein said GPS signal processing means utilizes a perfect reference.

4. A method for building a database of Wi-Fi signal-strength contours within a geographical area of interest, said method comprising:
deploying one or more mobile Wi-Fi database-building devices throughout said geographical area of interest; wherein each of said one or more mobile Wi-Fi database-building devices has a GPS receiver and a Wi-Fi signal transceiver; and each periodically measures and records a composite GPS signal concurrently with a Wi-Fi signature comprised of signal-strength contour IDs, which in turn are comprised of the IDs and associated signal strengths of Wi-Fi access points detectable at the point of measurement;
deriving, from each composite GPS signal, positioning parameters associated with acquirable GPS satellites:
constructing surfaces of location using positioning parameters so derived:
storing surfaces of location, each with its associated Wi-Fi signature, in a surfaces of location database;
estimating, from surfaces of location sharing a common Wi-Fi signature, the location of said common Wi-Fi signature;
storing Wi-Fi signatures, each with its estimated Wi-Fi signature location, in a Wi-Fi signature database;
aggregating, for each unique signal-strength contour ID, the estimated Wi-Fi signature locations corresponding to the Wi-Fi signatures comprising said signal-strength contour ID, into a signal-strength contour point set;
constructing a signal-strength contour for each signal-strength contour point set, by fitting the points of said signal-strength contour point set with a non-self-intersecting curve; and
storing said signal-strength contours, each with its unique signal-strength contour ID, in a signal-strength contour database.

5. The method of claim 4, wherein the composite GPS signals span multiple cycles of GPS' 50 Hz data overlay.

6. The method of claim 5, wherein the derivation of positioning parameters associated with acquirable GPS satellites, from a composite GPS signal, is accomplished utilizing a perfect reference.

7. The method of claim 4, wherein estimating the location of said common Wi-Fi signature is accomplished by estimating the approximate location of the one or more mobile Wi-Fi database-building devices at such times as said common Wi-Fi signature was measured and recorded, determined as the point for which the sum of the squares of the distances to each of three or more surfaces of location sharing said common Wi-Fi signature is minimized.

8. The method of claim 7, wherein one of said three or more surfaces of location sharing said common Wi-Fi signature is a sphere centered at the earth's center with a radius corresponding to the mean elevation measured over said geographical area of interest.

9. The method of claim 4, wherein the construction of signal-strength contours is further constrained to insure that signal-strength contours with signal-strength contour IDs sharing a common Wi-Fi access point ID, do not intersect.

10. A method for estimating the location of a mobile Wi-Fi signal receiver within a geographical area of interest, said method comprising:
building a database of independently-obtained survey data obtained within a geographical area of interest, each survey datum including a surface of location derived from a composite GPS signal, and a Wi-Fi signature, both the composite GPS signal and the Wi-Fi signature having been measured and recorded concurrently;
receiving at said mobile Wi-Fi signal receiver, messages transmitted by Wi-Fi access points within range of said mobile Wi-Fi signal receiver, each message including the ID of the transmitting Wi-Fi access point;
calculating the received signal strength of each of the messages received by said mobile Wi-Fi signal receiver;
pairing the IDs of the transmitting Wi-Fi access points with their associated received signal strengths, to form signal-strength contour IDs;
assembling said signal-strength contour IDs into a mobile Wi-Fi signature;
extracting from said database of independently-obtained survey data, an algorithmically-determined subset of surfaces of location, utilizing said mobile Wi-Fi signature; and
estimating the location of said mobile Wi-Fi signal receiver using said algorithmically-determined subset of surfaces of location.

11. The method of claim 10, wherein the algorithmically-determined subset consists of those surfaces of location with Wi-Fi signatures identical to the mobile Wi-Fi signature; and wherein the estimate of the location of said mobile Wi-Fi signal receiver is determined as the point for which the sum of the squares of the distances to each of the surfaces of location included in said algorithmically-determined subset is minimized.

12. The method of claim 10, wherein the algorithmically-determined subset consists of those surfaces of location with the property that each of their associated Wi-Fi signatures shares at least one signal-strength contour ID with the mobile Wi-Fi signature; and wherein estimating the location of said mobile Wi-Fi signal receiver is accomplished by:
constructing signal-strength contours for each of the signal-strength contour IDs composing the mobile Wi-Fi signature, using the surfaces of location included in said algorithmically-determined subset; and
estimating the location of said mobile Wi-Fi signal receiver using said signal-strength contour(s).

13. The method of claim 12, wherein the mobile Wi-Fi signature comprises three or more signal-strength contour IDs; and wherein the estimate of the location of said mobile Wi-Fi signal receiver is determined as the point for which the sum of the squares of the distances to each of said signal-strength contours is minimized.

14. A method for estimating the location of a mobile Wi-Fi signal receiver within a geographical area of interest, said method comprising:
building a reference database of Wi-Fi signal-strength contours within a geographical area of interest, wherein said reference data base is comprised of signal-strength contours, each with its associated signal-strength contour ID; and wherein said reference database is compiled from a database of independently-obtained survey data, each survey datum including a surface of location derived from a composite GPS signal, and one or more signal-strength contour IDs, both the composite GPS signal and the one or more signal-strength contour IDs having been measured and recorded concurrently;
receiving at said mobile Wi-Fi signal receiver, messages transmitted by Wi-Fi access points within range of said mobile Wi-Fi signal receiver, each message including the ID of the transmitting Wi-Fi access point;
calculating the received signal strength of each of the messages received by said mobile Wi-Fi signal receiver;
pairing the IDs of the transmitting Wi-Fi access points with their associated received signal strengths, to form signal-strength contour IDs;
assembling said signal-strength contour IDs into a mobile Wi-Fi signature;
extracting from said reference database of Wi-Fi signal-strength contours, the signal-strength contour(s) corresponding to the signal-strength contour IDs composing the mobile Wi-Fi signature; and
estimating the location of said mobile Wi-Fi signal receiver using said signal-strength contour(s).

15. The method of claim 14, wherein the mobile Wi-Fi signature comprises three or more signal-strength contour IDs; and wherein the estimate of the location of said mobile Wi-Fi signal receiver is determined as the point for which the sum of the squares of the distances to each of said signal-strength contours is minimized.
